(19) United States
(12) Patent Application Publication
(10) Pub. No.: US 2010/0257013 A1
(43) Pub. Date: Oct. 7, 2010

(54) Apparatus for scheduling staff based on performance

(76) Inventor: Philip H. Beauregard, Westport, MA (US)

Correspondence Address: ROBERT K. TENDLER, 65 ATLANTIC AVENUE, BOSTON, MA, 02110, US

(21) Appl. No.: 12/384,556

(22) Filed: Apr. 6, 2009

(51) Int. Cl. G06Q 10/00; G06Q 99/00; G07G 1/12

(52) U.S. Cl. 705/9; 705/8; 705/16; 705/17

(57) ABSTRACT

Apparatus is provided for scheduling of service staff based on their performance, in which in one embodiment performance is measured by sales associated with a staff member and gratuities related to the sale. For the restaurant sales performance is measured by adjusted gross sales per diner and gratuities includes tip percentage the staff member receives, with staff performance being measured by a score that includes sales and gratuities modified by a merit/demerit point system. In this embodiment tip percentage may be calculated per shift.

### FIELD OF THE INVENTION

This invention optimizes service staff performance and provides a scheduling apparatus with incentivizing service staff to please customers and increase sales.

### BACKGROUND OF THE INVENTION

Inherent in the restaurant industry is complacency of service staff, an innate quality of the restaurant workforce. Service staff-typically a waiter, waitress or bartender, should focus on maximizing customer satisfaction and good will, resulting in higher receipts. Servers can become comfortable with a certain level of performance regarding their sales and the amount they receive in tips. However, this comfort level is counterproductive to the restaurant's desire to grow. Those with longer tenure expect to have their pick of shifts. Most seek to work the best shifts, e.g. Friday nights, when the sales and tipping are highest.

Moreover, cliques come into play, as well as internal politics between service staff and management. Also, there may be favoritism in the manager's treatment of the workforce with respect to scheduling.

One of the largest concerns for restaurant management is scheduling. Scheduling bears directly on an employee's earning capability. Note, there is a large difference in tips earned between a Monday lunch shift and a Friday night dinner shift. In a small enterprise, waiters might typically earn $20 during a Tuesday lunch shift, but as much as $200 on a Friday night shift. Thus, service staff typically strives to secure the most desirable shifts.

However, there is no mechanism presently in place that gives restaurant management the ability to schedule service staff with a comprehensive logistics program based on incentive and performance. A merit-based system that encourages better service and better profits for the owners of the establishments is required. Moreover, there is a requirement for staffing apparatus that allows the servers to control their own fate and earning potential.

Scheduling is a crucial concern for restaurant owners because service staff function as the front line of the restaurant. Service staff members are the first point of contact for customers and guide the guest through his or her experience, the food itself only going so far. The restaurant industry is a customer service industry. Studies show that patrons who leave unsatisfied may tell twenty friends that they had a bad experience, whereas if they leave satisfied they will tell only two. Thus, service staff determines the word-of-mouth reputation of the restaurant.

In terms of restaurant profits, the duty of the service staff should be to up-sell. For instance, the server may say seek to ascertain if the customer has a preferred vodka, “do you have a preference in vodka?” They can up-sell because well vodka provides less margin for the restaurant than selling a premium brand. On the other hand, premium vodkas, which are at a higher price point, provide a larger profit margin and usually a better product for the patron (thus also adding to their experience).

The same up-selling occurs with various menu items. For instance, the server may push a higher priced/margin appetizer by telling the patron that the restaurant has a really good crab cake dish. A server may simply encourage a guest to purchase a dessert when they weren't planning to in the first place. Each instance increases a restaurant's bottom line. Service staff members are thus encouraged to suggest what the customer should buy, and that they should buy more.

For example, consider a small enterprise with ten servers, five scheduled for the lunch shift and five for the dinner shift. James Sullivan, a well-known industry analyst, asserts that up-selling works 58-72% of the time. If each of these servers accommodate five tables during a shift, and if they are able to up-sell $4 for a menu item 58% of the time, by the end of the year the increase in revenue to the restaurant will be upwards of $70,000, assuming that the restaurant is open 300 days a year. So if the ultra conservative worst-case scenario is that the service staff only manages to add $4 an item 58% of the time, then the up-selling campaign is a land office success.

As to prior methods of scheduling, scheduling is done by the manager in a manual pencil and paper operation where the manager sits for several hours, doing a months worth of scheduling based upon what the service staff have written down as to their availability. Service staff advises managers of their availability during a specific time period and the manager then creates a schedule for the month. The manager has an idea of whom he wishes to place on the Friday night shifts. However, the largest problem in the industry is when favoritism, nepotism, or even tenure comes into play. For instance, managers often automatically give the server who has been there 25 years the Friday night shift. Others might give the Friday night shift to their best friends. Managers usually range between 25 and 35 years in age and oftentimes their best friend works at the restaurant. If such is the case the manager will frequently schedule them for Friday nights as much as possible.

However, this is deleterious to the restaurant business because the management is not necessarily putting the best seller at the appropriate shift. The best seller is the person who is pleasing the customer the most and selling the most product, and should be scheduled on nights for which there is the maximum potential for revenue and customer face time.

Scheduling software such as ScheduleFly and HotSchedules utilize semi-automated computer systems to schedule based solely on the availability of the staff and the labor forecast. The labor forecast is what the restaurant thinks the amount of servers and hours should be for a given day according to their estimates of how much food and beverage they are likely to sell. However, none of the above scheduling software considers service staff performance or provide fully-automated schedule generation.

### SUMMARY OF THE INVENTION

In contradistinction to prior manual and computerized systems based solely on availability and labor forecast, the subject apparatus involves a performance-based scheduling system based on scores for the staff in which the top performing staff members are awarded the best shifts. This system puts the restaurant's best face forward at times where there is the most potential for sales. Most importantly, it encourages the highest levels of customer satisfaction coupled with the highest level of sales.

The subject performance-based system creates a competitive environment based on microeconomic principles that theorize that when competition arises, one can get the most efficiency out of a resource in this case the service staff. When servers know that their scheduling, their pocket money, and in fact their livelihoods are based on their performance, they will compete to get the best shifts and thus generate the larger amounts of money, not only for themselves, but also for the enterprise. They will balance this with maintaining the highest standards of customer satisfaction, resulting in exponential revenue generation for the enterprise moving forward.

If servers come in feeling ill or having a really bad day, and if they don't up-sell at every opportunity, their scores will be lowered, meaning that they will be given less desirable shifts. This in turn costs the server money and aligns the interests of the server with those of the restaurant.

Note that when a server has a bad day, this costs the restaurant both in reduced sales and negative customer experience.

In the subject invention a scheduling module is coupled to a point of sale device (POS) from which sales and tips data are available. The scheduling module implements a linear grading algorithm in which the formula derives a raw score by measuring individual components of employee performance and factors them into a summarized score.

The first component is sales ability and is based on adjusted gross sales per diner. It is noted that there are going to be differences in ability to sell based on the menu, the shift, and the price of the items during that shift. For instance a piece of steak at lunch is going to cost perhaps around 20% less than the same piece of steak at dinner. Thus, sales off the lunch menu are going to be less than sales off the dinner menu.

Therefore, the sales ability portion of the subject algorithm includes a menu price index, MPI, in which all the prices on each menu are totaled, with the dinner menu sales in practice being discounted to be equivalent to those of lunch menu sales. This adjusted gross sales factor is then divided per diner to achieve parity for a server's sales during any given shift, regardless of menu prices or customer traffic.

Thus, if one has a slow shift at lunch where the server only accommodates two tables, whereas a second server comes in Friday night and serves twenty tables, the number of tables is taken out of the equation by using a per diner metric. There is equivalence in the scoring system in the menus and the ability to sell so as to put all servers on par. It is therefore one aspect of the subject invention that the ability to sell includes adjusted gross sales per diner, the first component of the formula used in the subject system.

As will be appreciated, by utilizing adjusted gross sales per diner, one derives a revenue function in the scoring system to enable the restaurant to see who is aligning their sales incentives with those of the restaurant.

The second component in the score is “customer satisfaction.” Restaurants don't want to push items on customers based solely on the establishment's need to increase sales. To do so would be reducing the restaurant business to an assembly line, rather than a customer service industry giving patrons a good experience so that they will return and tell their friends. The industry is a well-known word of mouth industry, so the customer satisfaction score component is highly significant.

Customer satisfaction in the subject invention is based on tips or gratuities. The purest way to judge how satisfied a customer is on average based on how large the tip is. One metric used in the subject invention is the percentage that the tip represents in terms of the bill.

In the subject invention the tips are tallied and scrubbed off or downloaded from a point of sales (POS) terminal, which makes available a tips database that cannot be manipulated by any of the managers. Thus, the second component in the score is arrived by scrubbing the credit card receipts from the point of sale system, by which the establishment can find out how the service staff has fared in a given shift, based on tip percentages. It is also within the scope of this invention to use gross tips, as opposed to tip percentages.

However, in the preferred embodiment if Mary has a 20% tip percentage, she in general is doing a better job on a given shift than Billy who only has an 18% tip percentage. Thus, the subject system allows the establishment to judge the server according to what the customer feels about the experience, and rates customer satisfaction in terms of the tip percent of the overall bill.

The subject system can optionally integrate a cash tipping system in which the server at cash out indicates to the establishment the total amount of tips they received. In so doing, the subject system takes away the moral hazard stemming from underreported tips. The reason is that the server's score is going to be lower if she underreports her tips and therefore will be assigned less desirable shifts. Thus, the server's ability to make money is going to be lower in the future if she underreports her tips. Of course if she over reports her tips in order to get a better score then she pays more in taxes.

The third component for the subject algorithm is a management defined component which in one embodiment results in merit and demerit points added to or subtracted from the score. The management defined component can involve nuances with various weights given to various different factors, adjusted in accordance with restaurant goals.

There are several server activities that would result in demerits. One could be physical appearance. For instance if a server does not shave for days, then he may be given a demerit. If a server is standing around when he or she is supposed to be doing side work, a demerit can be given.

However, in one embodiment when giving a demerit the subject invention requires the management to give the reason for the demerit. To avoid favoritism; management is required to account for point manipulation.

There are also merit points that can be added to the score for the server. Merit points, for instance, can be earned based on positive customer comment cards. Also, a merit point may be afforded to staffers making an exemplary effort in bringing hot food to the tables or helping out their fellow service staff, or simply by increasing operational efficiency by clearing off tables that are not assigned to them.

Thus merits and demerit points can be centered around positive customer comments, neatness, relationship to the cooking staff, tardiness, cell phone usage and texting, not doing side work, not washing hands, not picking up someone's shift, and wasting food. Wasting food comes into play when the server does not get the order correct. For instance, if the server orders the wrong type of steak then the item is a wasted item.

In the subject system the emplaced POS equipment in the restaurant is utilized to scrub data. The POS system holds all of the information about the restaurant so management can be apprised of the sales, the quantities and items sold and at what times, by whom and to how many tables, even keeping track of the number of people at a table and gratuities received, along with other data sets.

In one embodiment, the subject invention provides access to the service staff so that scoring is accessible by both staff and management.

It is central to the subject invention that the score generated by the subject apparatus determines the roster or schedule, such that the subject invention rosters employees according to their scores from top to bottom. The system also has an input related to the availability of each of the service staff; and part of the subject invention is such that if a top scoring staff member cannot work on a Friday night the system will automatically provide him or her with the next best shift.

Thus, there is a hierarchy of desirable/profitable shifts, forming one of the inputs to the rostering module in which the server with the highest score is placed in a shift that is determined by the hierarchy to be the best shift, i.e. most potential for revenue generation and customer face time.

In summary, the subject apparatus provides the establishment with the ability to schedule staff based on the best potential for customer satisfaction and ability to sell, which is in turn based on objective data.

This enables the restaurant to schedule the best of the service staff at the most profitable times of the week and eliminates deadweight loss by providing a schedule that is the best use of service staff. As a result, the subject apparatus creates an efficiency where there was none.

It is in the interest of the establishment to want the best server who makes the customers the happiest and sells the most, according to the historical data, this server is placed front and center on the night with the most customers.

In one embodiment, the scoring system and its inner layers are accessible by the service staff via a web portal. This empowers the server to fix their performance and tweak it to see what exactly they have done right, what they have done wrong and what they need to do to improve and move forward in a positive manner for both themselves and the restaurant.

Note that the incentives for the server and the restaurant are aligned. Servers want to sell more because they will get a higher amount of tips, and the restaurant wants them to sell more because the restaurant will make a higher profit. The restaurant wants the servers to treat the customer better because the customer will not only come back, but also tell people about it, which means increased future traffic. The server wants to treat customers better because the customers tip better when they have a more pleasant experience. Thus, all incentives are aligned.

In summary, apparatus is provided to schedule or roster service staff based on performance, with performance measured by a score that includes adjusted gross sales per diner, the tips or tip percentages that the service staff receive, and merit and demerit points under the control of the restaurant management. The subject system takes out favoritism and combats complacency by quantifying server performance and providing server competition in a manner intended to increase restaurant revenues and provide a better, more pleasant experience to restaurant guests.

### BRIEF DESCRIPTION OF THE DRAWINGS

These and other features of the subject invention will be understood in connection with the Detailed Description in conjunction with the Drawings, of which:

FIG. 1 is a diagrammatic illustration of the use of the subject apparatus in a restaurant scene in which a point of sale terminal is scrubbed, data is downloaded to a roster generating module that incorporates a server scoring algorithm, and an optimized roster or schedule is generated;

FIG. 2 is a diagrammatic illustration of the algorithm utilized in which sales are combined with customer satisfaction and a management defined set of parameters to provide a raw score;

FIG. 3 is a diagrammatic illustration of the sales component of the subject algorithm, including derivation of score statistics and the parity created between breakfast, lunch and dinner menus, normalizing different shifts for the purpose of objectively determining sales ability;

FIG. 4 is a diagrammatic illustration of the ability to obtain customer satisfaction in terms of the tip percentage a server receives;

FIG. 5 is a diagrammatic illustration of the management defined input, in which merit and demerit points are added or subtracted from the score to adjust for management-defined criteria;

FIG. 6 is a diagrammatic illustration of the process flow utilized by the roster module to provide optimized scheduling, including development of adjusted gross sales per diner and tips scrubbed from point of sale data, which are combined with management defined merit and demerit points to obtain a raw score that also takes into account the availability of staff; and,

FIG. 7 is a diagrammatic illustration of the hardware components of the subject invention including a point of sale terminal, a rostering module, a display for the optimized roster/schedule and a roster printer.

### DETAILED DESCRIPTION

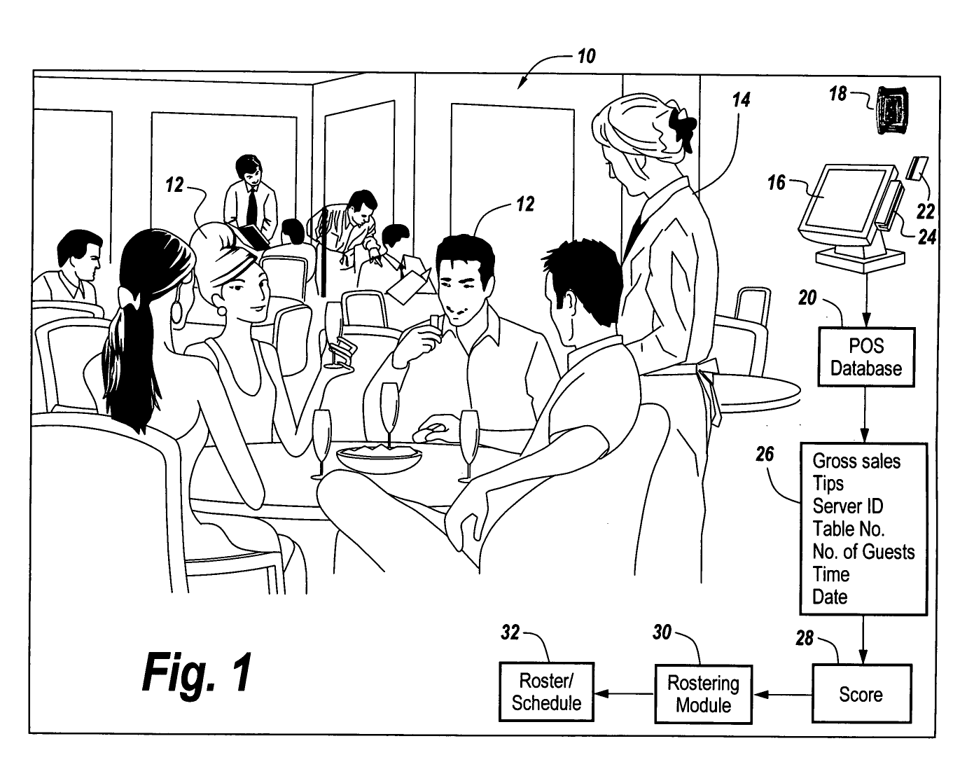

Referring now to FIG. 1, a restaurant scene 10 is depicted in which customers 12 are being waited on by a server 14. The server takes the customers' orders and inputs them directly into a point of sale (POS) terminal 16 or wirelessly via handheld point of sale terminal device 18 in order to populate a point of sale database 20.

After the meal, a bill or check is presented by the server and is paid for in one embodiment by a credit card 22, which is slid through a credit card reader 24.

The result of the ordering and the credit card transaction is a scrubbing or downloading of point of sale data 20 to output gross sales, tips, server identification, table number, number of guests at the table, time and date as illustrated at 26 which is the data used to provide a score 28 to a rostering module 30 that utilizes this score and produces an optimized roster or schedule 32.

The objective is to provide a platform to automate the particular restaurant business function while optimizing performance. The subject invention provides an automated apparatus that maximizes revenue and customer satisfaction for the restaurant. It also allows management and staff to access business intelligence for purposes of establishing best practices. The subject invention encourages compliance, which is quick and easy to implement with minimal manual input and maintenance, resulting in an instantaneous and dramatic return on investment.

As mentioned above, one of the largest problems in the restaurant industry is staff underperformance and apathy. Complacency, as illustrated by the notion that senior staff members have their choice of shifts, is not best case for restaurant scheduling. Moreover, managers are often unconsciously adhering to unspoken rules of staffing and can often fall victim to favoritism in the workplace. The subject apparatus, through the scoring described herein, provides competition that stimulates innovation and increases efficiency. It encourages staff to put their best foot forward at all times, to actively sell as much product as possible and to keep the customer's ultimate satisfaction in mind. The system affects server income and competition increases their performance, rewarding to those who perform, and giving them the shifts where opportunity to make money is the greatest.

The establishments that can benefit from the utilization of the subject system are those who wish to increase same store sales and revenue while streamlining operational efficiency and dramatically improving customer satisfaction.

The system also relieves managers who spend extra time scheduling and aids managers who would like to avoid politics surrounding scheduling. The system also permits managers and service staff to analyze objective data for the sake of improving performance metrics. As a result, the system benefits servers who wish to be compensated for good performance.

In one embodiment there are three distinct components accessible by a web-based portal. The first and most important is the optimization engine that feeds a dynamic scheduler and in turn provides business intelligence to a business intelligence portal and data analyzer.

As seen in FIG. 2, the system for downloading point of sale terminal data providing the raw score for the generation of a schedule or roster is comprised of three components. The first is sales, the second is customer satisfaction and the third is a management-defined variable. The subject invention includes a rostering module that generates a raw score and schedules the staff in a hierarchical pattern, with those scoring the highest being placed during the busiest shifts.

The raw score in one embodiment is computed over a discrete period of time enabling a “clean slate” every period for an employee to outperform other employees and thus attain better shifts.

Note that employees with the highest scores are placed into a schedule during shifts with the greatest sales or customer face time potential, historically derived or ranked by management, taking into account constraints or availabilities entered previously. Thus, the system may be customized for each business.

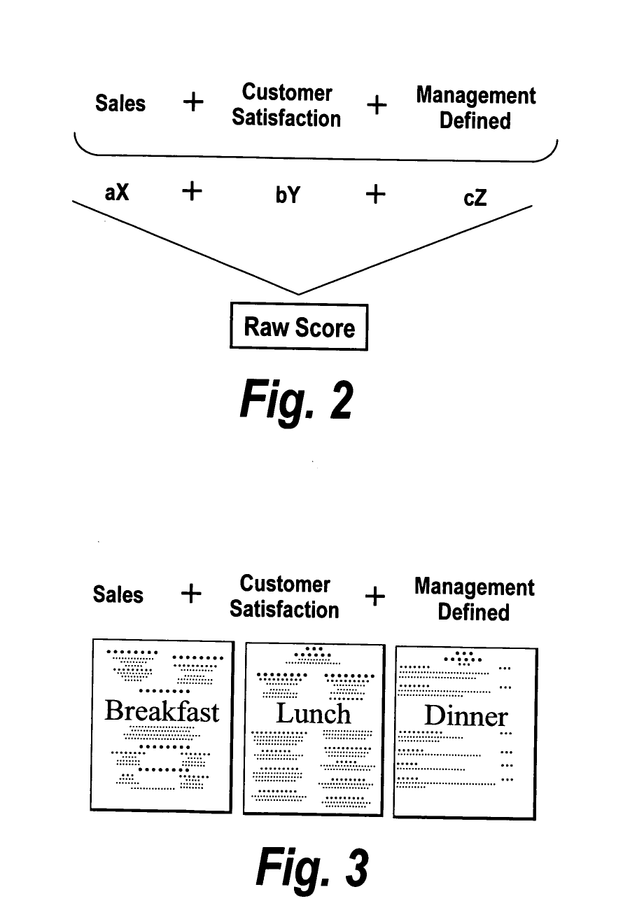

As to sales, as depicted in FIG. 3 the sales can occur at a breakfast, lunch or dinner shift normalized via a menu price index computed off the total value of the items on each shift's menu. Note that certain items can be removed from scoring such as kids menu items, voids or split dinners.

In the subject system server sales are normalized by the menu price index in order to make all sales equivalent. Thus, if the lunch menu is worth 77% of the dinner menu, a server working the dinner shift will have sales adjusted 33% lower to normalize the scoring output.

A server's total menu price index adjusted sales for a given shift are then divided by the number of customers serviced, resulting in an adjusted gross sales per diner metric. This is the first component of the server's raw score.

Customer satisfaction is the second component of the score, best measured by the tip percentage a server receives. It is a feature of the subject invention that servers can be distinguished in terms of tip percentage.

The subject system downloads the data off the restaurant infrastructure system point of sale terminal at the end of each shift and computes the tip percentage a server made during the shift.

During the defined time period the percentage will be computed for all of the server's shifts and will be entered into their customer satisfaction score component.

It is an optional feature of the subject invention that cash tip percentage can be ascertained and utilized by the rostering module, forcing the server to either report tips accurately for added tax compliance, or suffer in raw score. Adding a cash-tip percentage to the subject system erases the moral dilemma associated with tip under-reporting.

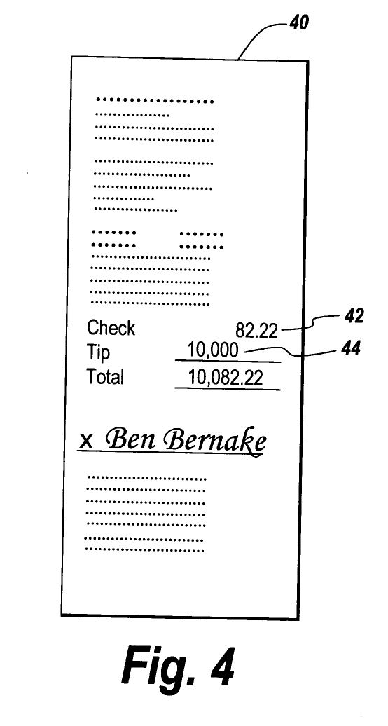

As can be seen in FIG. 4, a typical check 40 includes the sales amount 42 and the tip 44 associated with the sale, with the sales slip totals being available from point of sale terminal output data.

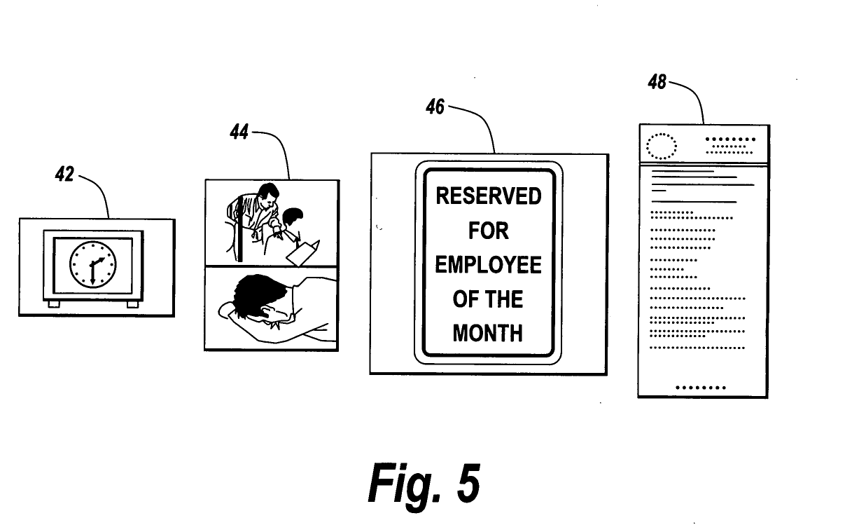

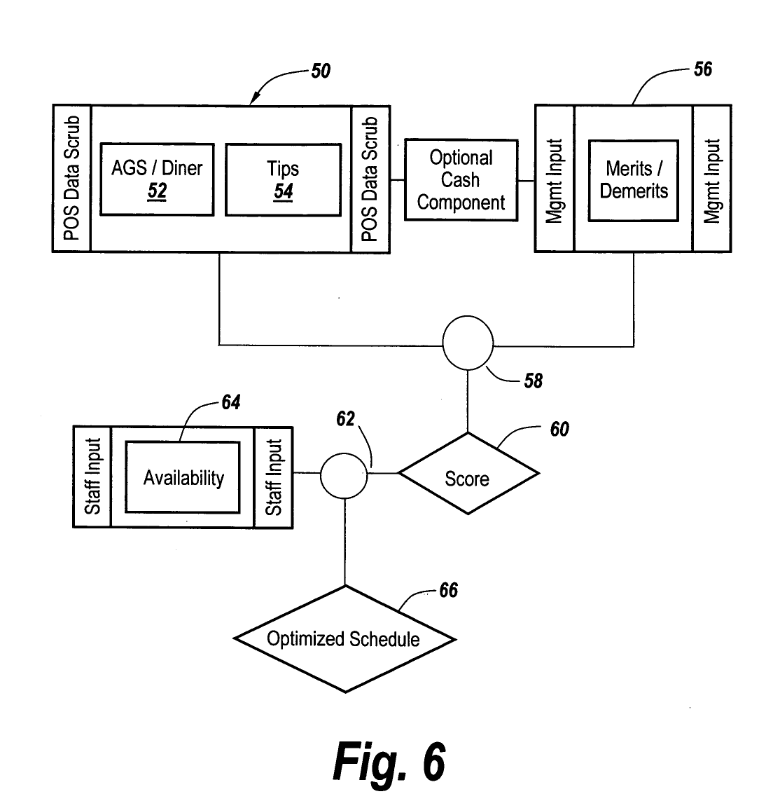

As shown in FIG. 5, management defined merit or demerit points are factored into the score with sales and customer satisfaction. As indicated above, demerits can relate to a timeliness issue as illustrated at 42, sleeping on the job as illustrated at 44, or may include merit points that relate to employee outperformance at 46 or positive customer experiences at 48.

The merit and demerit categories in one embodiment are available in a pick-list format, with management able to add specific categories to increase user friendliness. Thus, category creation and value manipulation is available with a click of the mouse. As a result, the component is controlled by management directive.

Note, as to numerical values, the demerit/merit system can be given less weight than gross sales per diner and tips. This component can therefore serve more as a tweak to the “raw score.”

Referring to FIG. 6, the restaurant optimization engine flow is shown. A point of sale terminal has its data scrubbed as illustrated at 50, with the data to include the adjusted gross sales per diner 52 and the tips 54 that a server obtains. Thus, sales and customer satisfaction is obtained as an output from the point of sale device. Merit and demerit points, which constitute the management defined function, are illustrated as being inputted at 56, which are then combined with the output from unit 50 at a module 58. The output of module 58 is a score 60 which refers to the server score for a predefined period.

A module 62 combines a “raw score” and the availability 64 of a server and generates an optimized schedule 66 as illustrated.

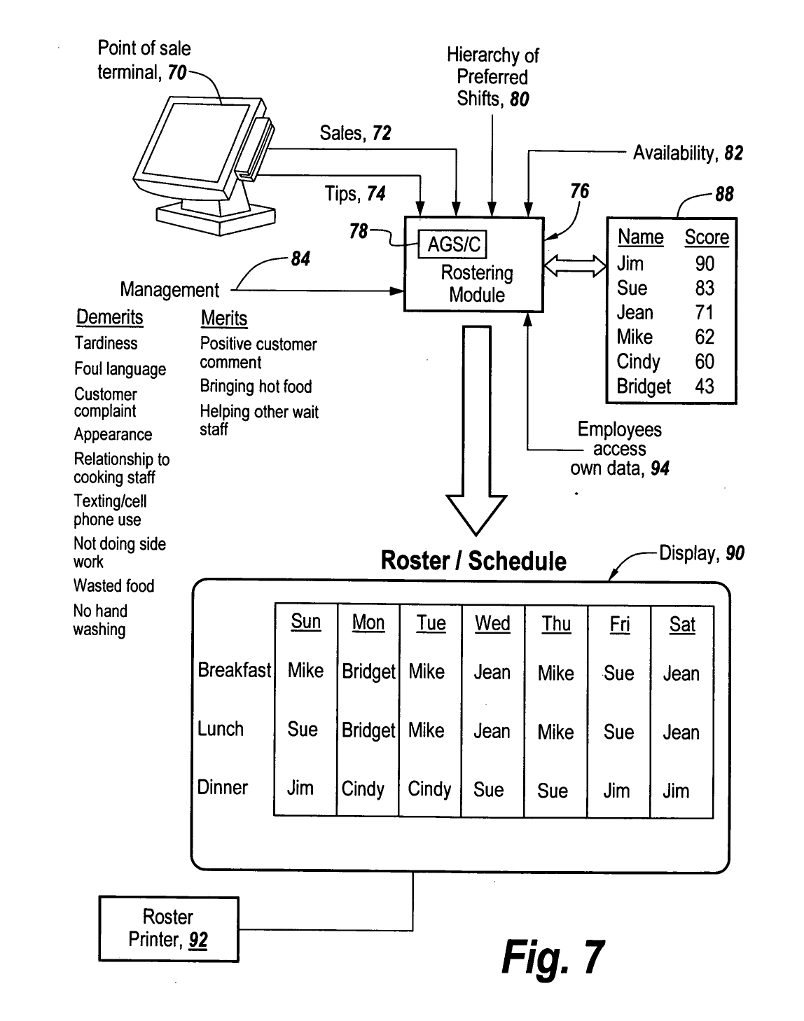

More particularly and referring now to FIG. 7, in terms of apparatus, a point of sale terminal 70 outputs sales 72 and tips 74 for a given server. Sales and tips are input to a rostering module 76, which calculates the adjusted gross sales per customer figure as illustrated at 78. It also calculates tip percentage. A hierarchy of preferred shifts is input by management at 80. Management can set up the hierarchy of shift desirability in terms of day of shift, section, shift type (double, single), shift time (day or night), and estimated duration, whereas server availability is inputted at 82. Availability can also be offset by employment labor law restrictions, e.g. maximum working hours per age group, and the time of day their shifts must end.

Finally, management parameters are input as illustrated at 84, which in one embodiment includes demerit and merit points. On the demerit side, tardiness, foul language, customer complaints, inappropriate appearance, bad relationship with cooking staff, text messaging or cell phone usage, not doing side work, wasted food and no hand washing result in demerits.

On the merit side positive customer comments, bringing hot food expeditiously and helping other service staff can result in merit points.

With all of inputs noted above, the rostering module generates a score card as illustrated at 88 which shows that Jim is the highest scorer at 90, whereas Bridget is the lowest scorer at 43, with Sue, Jean, Mike and Cindy ranked in between.

Rostering module 76 populates a display 90 in terms of a schedule, indicating breakfast, lunch and dinner shifts for a week, and indicates which servers will operate in selected shifts. The roster also places service staff in sections within a restaurant that are most desirable, e.g. Section 1 is busier than Section 4. Taking the Friday shift which is in general the more desirable and higher revenue shift, it can be seen that for breakfast and lunch Sue, who is ranked second at a score of 83, is provided with these shifts, whereas the super lucrative dinner shift is awarded to Jim with the highest score.

Monday, generally acknowledged to be the least desirable of the days, is given to Bridget for breakfast and lunch, and Cindy for dinner.

The individuals with the highest scores are provided with the most lucrative and desirable shifts taking into account their availability.

As mentioned hereinbefore, if a server having the highest score is not available for a given shift then the award is made to the next highest-ranking server.

The contents of the display is available at a roster printer 92 so that hard copies can be circulated amongst the staff, whereas employees may also access their own data remotely as illustrated at 94.

What will be seen is that while scheduling software exists, nowhere in this software is an optimization model that is based on server performance. By using the subject invention it is possible to ascertain from point of sale data the performance of a given server over a predetermined period of time and to schedule servers most likely to generate income and goodwill for the restaurant in the more desirable shifts. The scoring apparatus provides a healthy competition amongst the servers and therefore increases efficiency of restaurant operation, with servers being able to ascertain where they are lacking in performance, and thereby improve their performance and thus the bottom line of the restaurant.

While the subject invention has been described in terms of its use in the restaurant industry, it will be appreciated that merit-based scheduling can be applied to a number of different industries.

As such, the subject invention includes any system in which performance is based on gratuities or tips and relates to any system which records the gratuities or tips and uses them in part as a factor in scheduling or rostering. The subject system includes for instance, tip based scheduling of taxi drivers, luggage handlers, hairdressers, limousine drivers, estheticians, massage therapists, or any scheduled services involving tips or gratuities.

While the present invention has been described in connection with the preferred embodiments of the various figures, it is to be understood that other similar embodiments may be used or modifications or additions may be made to the described embodiment for performing the same function of the present invention without deviating therefrom. Therefore, the present invention should not be limited to any single embodiment, but rather construed in breadth and scope in accordance with the recitation of the appended claims.

What is claimed is:

1. Apparatus for the scheduling of staff of an enterprise based on performance, comprising:
a point of sale terminal capable of recording sales related to a staff member and gratuities associated with said sale, and;
a rostering module coupled to said point of sale terminal for calculating staff performance in terms of a score that includes sales and gratuities for said staff member, said rostering module generating a roster/schedule for scheduling staff members in scheduling slots based on said score, whereby scheduling reflects staff member score.

2. The apparatus of claim 1, wherein said rostering module includes as an input a hierarchy of scheduling slots, and wherein the schedule generated by said rostering module places those with higher scores in more favorable scheduling slots.

3. The apparatus of claim 2, wherein said enterprise includes a restaurant having a number of diners and wherein said score is in part based on gross sales per diner.

4. The apparatus of claim 3, wherein said gross sales per diner is adjusted based on shift.

5. The apparatus of claim 1, wherein said score is weighted by management-defined merits and demerits, whereby staff members with demerits are provided with a score reduced by a factor related to demerits and wherein said score is increased by a factor related to merits.

6. The apparatus of claim 1, and further including a staff member terminal and a network for coupling said staff member terminal to said rostering module for permitting a staff member to ascertain staff member score, whereby a staff member can be made to understand the rationale behind assignment of a scheduling slot.

7. The apparatus of claim 1, and further including means at said rostering module for reporting to a staff member the components of the associated with said staff member score.

8. The apparatus of claim 7, wherein said components include merits and demerits relating to a staff member, wherein said staff member is given the opportunity to minimize activity causing demerits and to maximize activity resulting merits, thus to align staff member goals with those of said enterprise.

9. The apparatus of claim 1, wherein said roster/schedule is associated with a gratuity-based service industry in which a staff member is scheduled for a schedule slot based on performance determined by sales and gratuities.

10. The apparatus of claim 1, wherein said sales and gratuities are modified with a management-specified merit/demerit weighting system based on staff performance, whereby staff member goals and the goals of said establishment are aligned.

11. The apparatus of claim 1, and further including a manual entry unit for entering cash receipts and gratuities into said point of sale terminal.

12. The apparatus of claim 1, and further including a module coupled to said rostering module for reporting staff member scores and the components thereof to management and to staff for staff motivation purposes for the staff to improve their performance and for management purposes to ascertain staff performance.

13. A system for scheduling establishment staff into scheduling slots based on performance, comprising:
a database for keeping track of staff member performance based on a combination of sales and gratuities, and;
a rostering module for scheduling staff members in a roster/schedule based on a score developed from said sales and gratuities, with the most desirable scheduling slot awarded to the staff member with the highest score.

14. The system of claim 13, wherein said establishment includes a restaurant and wherein said sales includes gross sales per diner.

15. The system of claim 14, wherein said gross sales is adjusted to equalize shifts.

16. The system of claim 13, and further including a display for displaying said roster/schedule.

17. The system of claim 16, wherein said display includes a printer for printing said roster/schedule.

18. The system of claim 13, and further including a unit for manually entering said sales and gratuities.

19. The system of claim 13, and further including a credit card reader for populating said database with sales and gratuity figures.

20. The system of claim 13, and further including a module for weighting said score based on a merit/demerit system in which a staff member is awarded merit/demerit points based on staff member activity.

21. The system of claim 20, wherein said weighting module includes demerits based on one of tardiness, foul language, customer complaints, appearance, relationship to other staff members, use of text messaging, use of cell phones, and the non-performance of work; and wherein said merits includes one of positive customer comments, efficient performance of services and helping other staff members.

22. The system of claim 13, wherein said rostering module is provided with a hierarchy of preferred shifts and wherein staff members having higher scores are provided with more desirable shifts.

23. The system of claim 13, wherein said establishment includes a restaurant and wherein said score is in part based upon tip percentage.

24. The system of claim 13, wherein said sales includes adjusted gross sales, the adjustments being made based on expected sales for a given shift.
